(19) United States
(12) Patent Application Publication
(10) Pub. No.: US 2014/0122448 A1
(43) Pub. Date: May 1, 2014

(54) INFORMATION PROCESSING APPARATUS, INFORMATION PROCESSING METHOD AND PROGRAM STORAGE MEDIUM

(71) Applicant: Kabushiki Kaisha Toshiba, Tokyo (JP)

(72) Inventor: Kaoru Nishiyama, Tachikawa-shi (JP)

(21) Appl. No.: 13/944,076

(22) Filed: Jul. 17, 2013

(30) Foreign Application Priority Data
Oct. 31, 2012 (JP) 2012-240583

(51) Int. Cl. G06F 17/30

(52) U.S. Cl. CPC G06F 17/30088
USPC 707/692

(57) ABSTRACT

According to one embodiment, an information processing apparatus includes a management controller, a determination module, and a receiver. When the deletion request is from a user other than a predetermined user, the management controller is configured to perform such control that, without deleting target data of the deletion request, the target data of the deletion request is not displayed to the user other than the predetermined user and the target data of the deletion request is displayed to the predetermined user.

### CROSS-REFERENCE TO RELATED APPLICATIONS

This application is based upon and claims the benefit of priority from Japanese Patent Application No. 2012-240583, filed Oct. 31, 2012; the entire contents of which are incorporated herein by reference.

### FIELD

Embodiments described herein relate generally to an information processing apparatus which manages data, an information processing method and a program storage medium.

### BACKGROUND

Conventionally, there is known an information processing system including a server which manages data, and a large number of clients. The data is stored on the server side, and is not stored in the clients. A user transmits a request relating to a data operation (e.g. data deletion, edit, etc.) from the client to the server.

An example of such a database system is a retrieve system. A retrieve server adds a delete target selection part to a list display of retrieve results, thereby enabling a retriever to select a delete target. A selected retrieve result is not displayed.

In conventional information processing apparatuses, the same process is executed in response to a data operation request, such as a deletion request, from any user, and the contents of data operations are not varied according to the kinds of users. However, among many users, there is a user like an administrator of the database, a user like an operator who simply inputs data, or a user who simply browses. A user like an administrator has a wider range of rights than other kinds of users and, in some cases, is permitted to execute a special data operation, which is different in content from data operations permitted to other users. Thus, there is a demand for varying the contents of data operations according to the kinds of users.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram illustrating an example of the configuration of an embodiment of a database system.

FIG. 2 is an exemplary flowchart illustrating a first half of an example of a process flow of the embodiment.

FIG. 3 is an exemplary flowchart illustrating a second half of the example of the process flow of the embodiment.

FIG. 4 illustrates an example of a record in the embodiment.

FIG. 5 illustrates an example of a screen display of a client which is used by an administrator in the embodiment.

FIG. 6 illustrates an example of a screen display of a client which is used by a user other than the administrator in the embodiment.

### DETAILED DESCRIPTION

Various embodiments will be described hereinafter with reference to the accompanying drawings.

In general, according to one embodiment, an information processing apparatus includes a management controller, a determination module, and a receiver. The management controller is configured to manage data. The determination module is configured to determine whether a user using an external device is a first user. The receiver is configured to receive from the external device a deletion request for deletion of data which is managed by the management controller. When the deletion request is from a user other than the predetermined user, the management controller is configured to perform such control that, without deleting target data of the deletion request, the target data of the deletion request is not displayed to the user other than the predetermined user and the target data of the deletion request is displayed to the predetermined user.

A first embodiment will be described hereinafter with reference to the accompanying drawings.

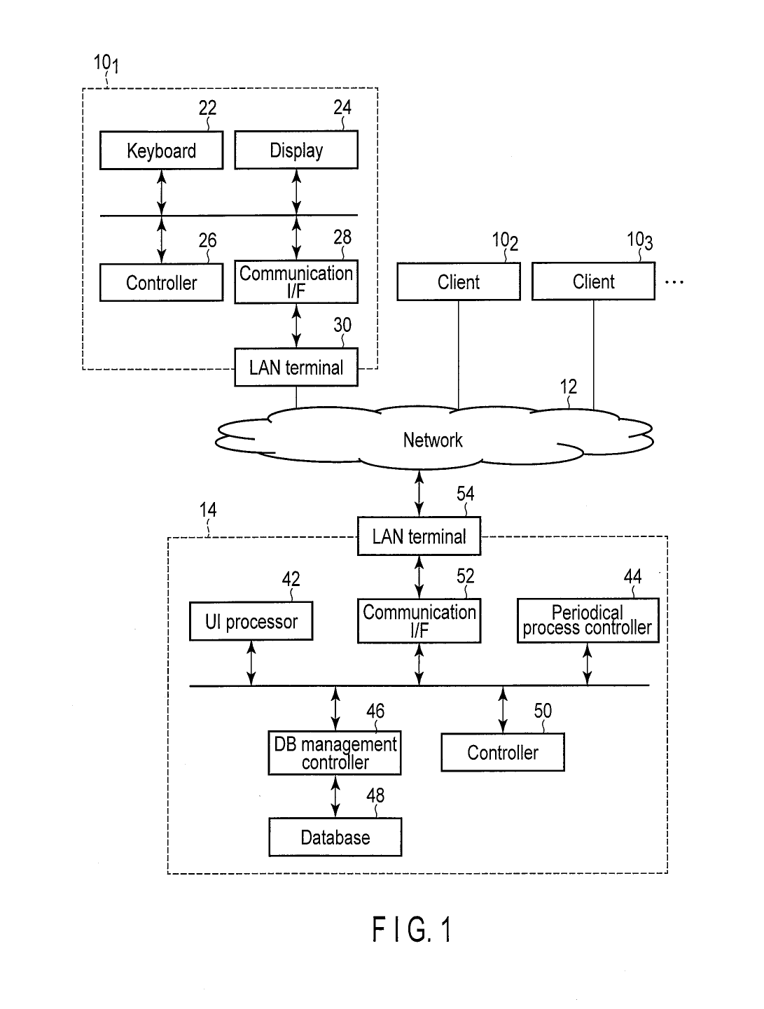

FIG. 1 is a block diagram illustrating the entire configuration of a database system. A plurality of clients 10₁, 10₂, . . . , are connected via a network 12 to a server 14 which includes a database. The network 12 maybe a LAN or the Internet.

An example of the client 10 is a personal computer. However, the client 10 is not limited to a personal computer, and a general information processing terminal, such as a tablet-type terminal, may be used. The client 10 includes a keyboard 22, a display 24 such as an LCD, a controller 26 such as a CPU, a communication interface (I/F) 28 for a wired LAN, and a LAN terminal 30 for connection to the network 12. The keyboard 22, display 24, controller 26 and communication I/F 28 are connected to a bus line. The controller 26 has a function of executing a client program (stored in an internal memory (not shown)) which controls the operation of the client, thereby transmitting a data operation request to the server 14, receiving a data operation result from the server 14, and displaying the data operation result on the display 24.

Users who operate the client 10 include an administrator of the database, an operator who simply inputs data, and a user who simply browses. When the use of the client 10 is started, the client program prompts the user to input a user ID. The client 10 or the server 14 can discriminate the kind of the user, based on the input user ID. Incidentally, in some cases, the server 14 manages the user ID as a client ID. The client ID in such cases is not the hardware-based ID of the client, but the ID of the user who is using the client.

The server 14 includes a user interface (UI) processor 42 which processes a request from the client 10, a periodical process controller 44 which executes a periodical process, a database 48, a database (DB) management controller 46, a main controller 50, a communication I/F 52, and a LAN terminal 54. The UI processor 42 receives a data operation request from the client 10, processes the request by controlling the database 48 via the DB management controller 36, and returns a data operation result to the client 10. The periodical process controller 44 periodically deletes actual data. The details of this will be described later. The UI processor 42, periodical process controller 44, DB management controller 46, main controller 50 and communication I/F 52 are connected to a bus line. The database 48 stores many files, each file comprises many records, and each record comprises various fields. The DB management controller 46 manages the database 48, based on commands from the UI processor 42 and periodical process controller 44. In short, the server 14 manages data.

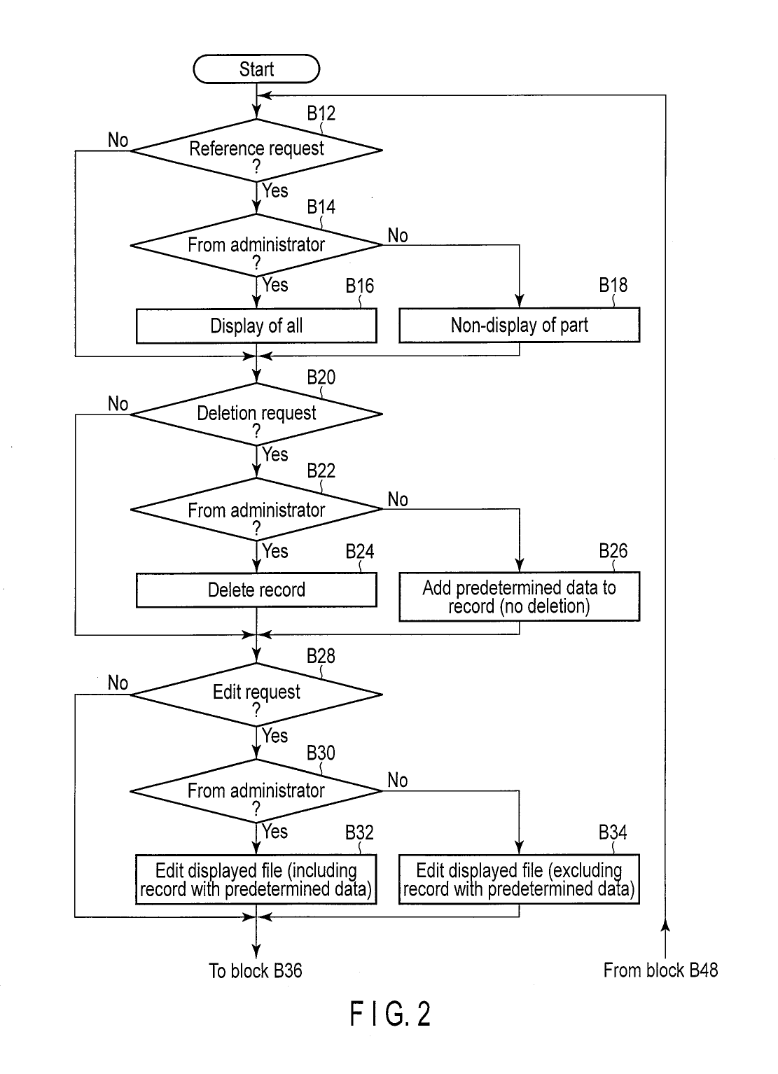

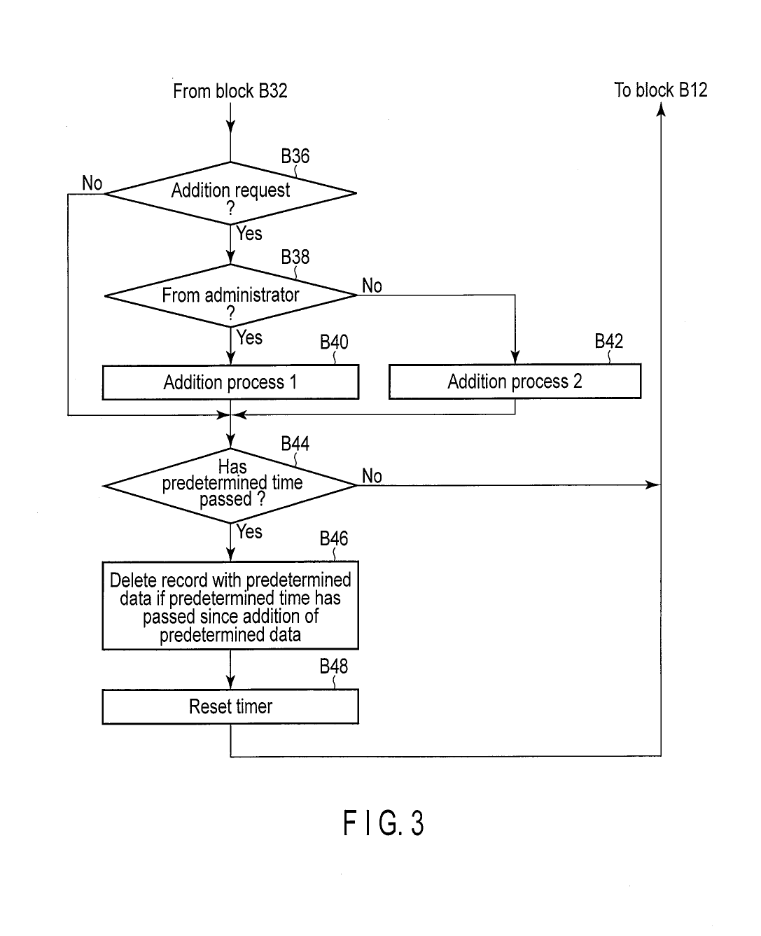

FIG. 2 and FIG. 3 are flowcharts illustrating a management process of the database by the UI processor 42 and periodical process controller 44 of the server 14. The flowcharts start when the user transmits a data operation request together with a user ID from the client 10 serving as an external device to the server 14. Although not illustrated, the flowcharts of FIG. 2 and FIG. 3 continue until the user terminates the process of the client 10. When the use of the client 10 is started, the user inputs the user ID. Data operations include, for example, reference, edit, deletion and addition, but the data operations are not limited to these, and may include retrieve, registration, etc. The reference is display, use, etc. of a file. The edit is a change of data in units of a field of a record. The deletion and addition are deletion and addition of data in units of a record. In the present embodiment, when the server 14 has received a data operation request, the server 14 determines whether the user who sent the request is a predetermined user (e.g. an administrator) or not, and alters the details of processes according to the result of the determination. The operation request also includes information which identifies an operation target (file, record, field, etc.).

In block B12, it is determined whether the data operation request received from the user is a reference request or not. In many cases, the target of a reference request is a file. However, in some cases, the target of a reference request is not the entire file, but a unit of some records in the file. When the reference request has been received, it is determined in block B14 whether the user who sent the reference request is an administrator or not.

When the reference request is sent from the administrator, all records of a file designated in the request are sent to the client 10 in block B16 and these records are displayed on the display 24.

When the reference request is sent from a user other than the administrator, only a specific record of all records of the file designated in the request is sent to the client 10 in block B18 and is displayed on the display 24, and the other records are not displayed. In this manner, such control is executed that the specific record is displayed to the administrator but is not displayed to the other users. The details of the specific record will be described later.

Next, deletion, edit and addition of a file, which is displayed on the display 24, are described. When the reception of a reference request is not detected in block B12, or after the display in block B16 or B18, it is determined in block B20 whether the data operation request, which has been received from the user, is a deletion request (including designation of a record) or not. When the deletion request has been received, it is determined in block B22 whether the user who sent the deletion request is the administrator or not.

When the deletion request is sent from the administrator, a command to delete a record designated in the request from the file is delivered to the DB management controller 46 in block B24. Incidentally, the deletion is not limited to completion deletion, and includes such a mode of deletion that the designated record is temporarily put in a Recycle Bin and then the record is completely deleted by emptying the Recycle Bin after a predetermined time period has passed or in accordance with an instruction from the user.

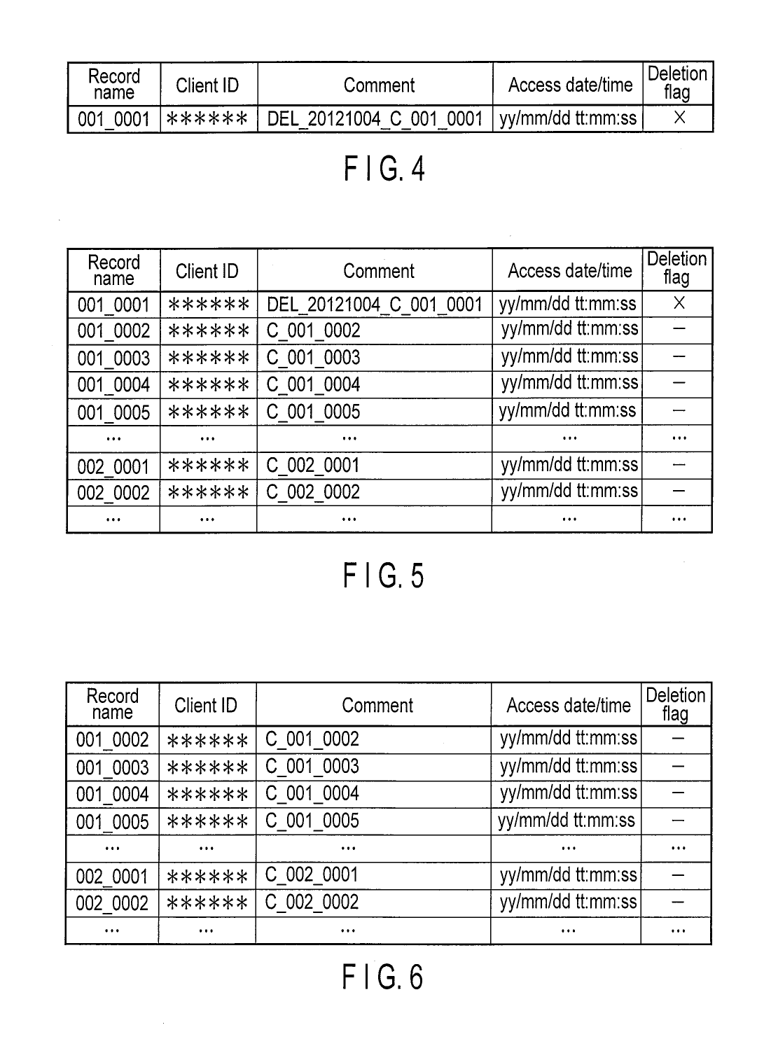

When the deletion request is sent from a user other than the administrator, a command to add predetermined data to the record designated in the request is delivered to the DB management controller 46 in block B26. The DB management controller 46 adds the predetermined data, but does not delete the record from the file. An example of the predetermined data includes a date of deletion and a deletion flag. The date of deletion is added to data of a predetermined field. The predetermined field is, for instance, a comment field. A comment can be freely written in the comment field, and “Del+deletion date” is added to the beginning of the comment. A deletion flag is set, for example, in a rightmost special field. The deletion flag is used in order to execute different processes in response to reference quests from different users. For example, a record, for which a deletion flag is set, can be referred to in response to a reference request from the administrator, but this record cannot be referred to in response to a reference request from a user other than the administrator. FIG. 4 illustrates an example of a record for which a deletion request has been issued from a user other than the administrator, and to which predetermined data has been added. The record includes fields of a record name, a client ID and an access date/time, in addition to the fields of the comment and deletion flag. Actually, the client ID is a user ID which identifies the kind of the user who uses the client.

Specifically, when the reference request is sent from a user other than the administrator, the client 10 displays only records (records for which deletion flags are reset) which are among the records of the file designated in the request and are other than the record to which the predetermined data has been added and for which the deletion flag has been set in block B26. In other words, the record for which the deletion flag has been set is not displayed. Thereby, the user of the client, other than the administrator, can recognize that the record has been deleted.

When the reception of a deletion request is not detected in block B20, or after the deletion process in block B24 or B26, it is determined in block B28 whether the data operation request, which has been received from the user, is an edit request (including designation of a record) or not. When the edit request has been received, it is determined in block B30 whether the user who sent the edit request is the administrator or not.

When the edit request is sent from the administrator, edit of the displayed file is executed in block B32. As has been described in connection with block B16, the display screen for the administrator includes the record, for which the deletion request was issued by the user other than the administrator, to which the predetermined data was added, and for which the deletion flag was set. Thus, the administrator can delete the predetermined data (and also reset the deletion flag) of a record for which a user other than the administrator erroneously issued a deletion request, and can cancel the deletion request.

When the edit request is sent from a user other than the administrator, edit of the displayed file is executed in block B34. As described in connection with block B18, the display screen for a user other than the administrator does not display the record for which the deletion request was issued and the deletion flag was set. In this manner, the contents of edit, which are permitted, are different between the administrator and a user other than the administrator.

When the reception of an edit request is not detected in block B28, or after the edit process in block B32 or B34, it is determined in block B36 whether the data operation request, which has been received from the user, is an addition request (addition of a record) or not. When the addition request has been received, it is determined in block B38 whether the user who sent the addition request is the administrator or not.

When the addition request is sent from the administrator, a first addition process for the administrator is executed in block B40. When the addition request is sent from a user other than the administrator, a second addition process for a user other than the administrator is executed in block B42. In this manner, the addition process is also different between the administrator and a user other than the administrator.

When the reception of an addition request is not detected in block B36, or after the addition process in block B40 or B42, it is determined in block B44 whether a predetermined time (e.g. one day) has passed or not, based on a count value of a timer. If the predetermined time has not passed, the process returns to block B12, and the process beginning with the presence/absence of the reference request is repeated. If the predetermined time has passed, an access date/time of a record, for which a deletion request was issued by a user other than the administrator, to which predetermined data was added and for which a deletion flag was set, is checked in block B46. The record, in connection with which the predetermined time has passed since the deletion request was issued by the user other than the administrator, is actually deleted. This aims at securing a time for canceling the deletion request, in a case where the deletion request was erroneously issued by the user other than the administrator.

Thereafter, the timer is reset in block B48, and the process returns to block B12. Then, the process beginning with the presence/absence of the reference request is repeated.

FIG. 5 and FIG. 6 illustrate examples of a display screen for the administrator and a display screen for a user other than the administrator, in a case where a reference request has been issued to a file including a record (001_{—}0001) for which a deletion request was issued from a user other than the administrator and to which predetermined data was added, as illustrated in FIG. 4. A symbol “x” in FIGS. 4 and 5 means that a deletion flag is set. A symbol “−” in FIGS. 4 and 5 means that a deletion flag is reset.

Specifically, when the administrator has issued a reference request, all records of the file designated in the request are displayed, as in block B16. Thus, as illustrated in FIG. 5, the record (001_{—}0001) shown in FIG. 4 is also displayed. Based on the characters DEL indicative of “deletion” in the comment field and the deletion flag that is set, the administrator recognizes that the deletion request for the record (001_{—}0001) was issued by a user other than the administrator. When cancellation of the deletion request was requested by the user other than the administrator or when the deletion was judged to be improper, the administrator issues an edit request, rewrites the comment field, deletes the characters DEL indicative of “deletion”, and resets the deletion flag.

When a user other than the administrator has issued a reference request, the record to which the predetermined data was added is not displayed, as in block B18. Thus, as illustrated in FIG. 6, the record (001_{—}0001) shown in FIG. 4 is not displayed. The user other than the administrator recognizes that the record (001_{—}0001) has been deleted.

As has been described above, according to the first embodiment, different deletion processes can be executed in response to deletion requests from different kinds of users. In addition, different reference processes can be executed in response to reference requests from different kinds of users. Thus, in response to a deletion request from a user other than the administrator, predetermined data is simply added to a record, and actually the record is not deleted. The record, to which the predetermined data was added, cannot be referred to (and is not displayed) in response to a reference request from a user other than the administrator, and this record is displayed in response to a reference request from the administrator. The record, to which the predetermined data was added, can be edited by the administrator, but cannot be edited by a user other than the administrator since the record is not displayed to this user. The record, to which the predetermined data was added, is actually deleted after the passage of a predetermined time. In this manner, the deletion request from the user other than the administrator can be canceled by the administrator, and erroneous deletion of data can be prevented.

In the above description, the number of kinds of users is two, namely an administrator and other users. Alternatively, three or more kinds of users may be identified, and processes corresponding to the kinds of users may be executed. For example, in response to a deletion request from a certain kind of user, a record for which a deletion flag is set may be displayed, as in the case of a display screen for the administrator. This kind of user, however, is unable to edit the record for which the deletion flag is set.

In the above description, the targets of processes, which are made different according to the kinds of users, are reference, deletion, edit and addition. Additionally, for example, a process for retrieval may be made different according to the kinds of users.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing apparatus comprising:
a management controller configured to manage data;
a determination module configured to determine whether a user using an external device is a first user; and
a receiver configured to receive from the external device a deletion request for deletion of data managed by the management controller,
wherein when the deletion request is from a second user, the management controller is configured to display target data of the deletion request to the first user and not to display the target data of the deletion request to the second user, without deleting the target data of the deletion request.

2. The information processing apparatus of claim 1, wherein the management controller is configured to delete the target data of the deletion request when the deletion request is from the first user.

3. The information processing apparatus of claim 1, wherein the management controller is configured to add predetermined data to the target data of the deletion request without deleting the target data, when the deletion request is from the second user.

4. The information processing apparatus of claim 3, wherein,
the management controller is configured to manage data comprising files, each of the files comprising records, and each of the records comprising a plurality of fields,
the deletion request comprises a specific deletion request for deletion of a specific record,
the predetermined data comprises a deletion flag, and
the management controller is configured to set the deletion flag for a target record of the deletion request from the second user without deleting the target record.

5. The information processing apparatus of claim 3, wherein the management controller is configured to display all records of a specific file to the first user, when the receiver receives a reference request for the specific file from the external device and the reference request is from the first user, and to display to the second user a record excluding an added record to which the predetermined data is added, when the receiver receives the reference request for the specific file from the external device and the reference request is from the second user.

6. The information processing apparatus of claim 3, wherein the management controller is configured to control so that data to which the predetermined data is added is editable, when the receiver receives an edit request from the external device and the edit request is from the first user, and to control so that the data to which the predetermined data is added is not editable, if the receiver receives the edit request from the external device and the edit request is from the second user, the data to which the predetermined data is added is not editable.

7. The information processing apparatus of claim 3, wherein the management controller is configured to delete the target data to which the predetermined data is added, after passage of a predetermined time from the addition of the predetermined data.

8. An information processing method of an information processing apparatus configured to manage data, the method comprising:
determining whether a user using an external device is a first user;
receiving from the external device a deletion request for deletion of data which is managed by the information processing apparatus; and
displaying the target data of the deletion request to the first user and not displaying the target data of the deletion request to a second user, when the deletion request is from the second user, without deleting target data of the deletion request.

9. A computer-readable, non-transitory storage medium comprising a program configured to be executed by a computer, the program controlling the computer to execute functions of:
determining whether a user using an external device is a first user;
receiving from the external device a deletion request for deletion of data which is managed by an information processing apparatus; and
displaying the target data of the deletion request to the first user and not displaying the target data of the deletion request to a second user, when the deletion request is from the second user, without deleting the target data of the deletion request.

10. The information processing apparatus of claim 4, wherein the management controller is configured to delete the target data to which the predetermined data is added, after passage of a predetermined time from the addition of the predetermined data.

11. The information processing apparatus of claim 5, wherein the management controller is configured to delete the target data to which the predetermined data is added, after passage of a predetermined time from the addition of the predetermined data.

12. The information processing apparatus of claim 6, wherein the management controller is configured to delete the target data to which the predetermined data is added, after passage of a predetermined time from the addition of the predetermined data.
